(19) United States
(12) Patent Application Publication
(10) Pub. No.: US 2003/0073487 A1
(43) Pub. Date: Apr. 17, 2003

(54) Game machine, game server, and game control method

(75) Inventor: Kazuo Okada, Tokyo (JP)

Correspondence Address: ANTONELLI TERRY STOUT AND KRAUS, SUITE 1800, 1300 NORTH SEVENTEENTH STREET, ARLINGTON, VA, 22209

(73) Assignee: ARUZE, Co., Ltd.

(21) Appl. No.: 10/271,758

(22) Filed: Oct. 17, 2002

(30) Foreign Application Priority Data
Oct. 17, 2001 (JP) 2001-319888

(51) Int. Cl. G06F 17/00

(52) U.S. Cl. 463/25

(57) ABSTRACT

A player change on each game machine is detected and, based on the detection result, the cumulative credit consumption on each game machine is controlled per player. When the cumulative credit consumption of a player reaches an upper limit, a return to the player is executed. At this time, if a predetermined upper limit value that is standard for return is relatively high, a return is less likely to occur. On the other hand, a relatively low predetermined upper limit offers poor game characteristics. In the present invention, a predetermined upper limit as standard for return is settable by the player's operation. This produces such circumstances that the player can perform a game without anxiety, while enjoying amusement of the game. It is therefore possible to eliminate the problem of missing customers.

### FIELD OF THE INVENTION

The present invention relates to a technique of controlling a return to game machines for pachislo game (Japanese slot game), pachinko game (pinball game), etc.

### BACKGROUND OF THE INVENTION

Generally, a game machine for pachislo game, pachinko game, etc. is constructed so that a game is started when a player throws a game medium such as medal, in the game machine, and that the game medium is paid out according to the winning state (style) occurred during the game.

This game machine generates a winning state, being called “big prize,” at a preset probability. Therefore, the player performs a game in expectation of a big prize on the game machine that the player is currently playing.

The game machine that produces a prize depending on the probability as described does not always produce the prize at a fixed probability. That is, it is constructed so as to converge on a preset probability when a significant number of games are digested. Therefore, a prize occurs on a player performing a small number of games, and a prize is not always guaranteed to a player performing a large number of games. With the game machine of this type, gambling characteristics can be enhanced to make the game more amusing. On the other hand, the player waiting for a prize for a long time might lose enthusiasm to the game. This leads to a tendency to lose the player (customer).

In order to solve the above circumstances, a variety of game machines have been proposed.

In a game machine disclosed in Japanese Patent Unexamined Publication No. 8-24401, there are two probability tables for controlling the probability of generating a big prize. In the case that the player performs a large number of games and gets tired of waiting for a prize, one of the two probability tables tat has a higher probability is selected for change, thereby increasing the probability of winning the prize.

Japanese Patent Unexamined Publication Nos. 6-79051 and 11-253640 have proposed game machines employing such means, being called “return.” The term “return” means a system that when predetermined conditions are satisfied, a game medium (e.g., medal) is paid out per game machine, depending on the amount of medals that a player threw in. A return type game machine of the former further increases game characteristics by controlling the return rate as a basis for payout of game media. On the other hand, a return type game machine of the latter adjusts the probability of generating a prize in consideration of the profit rate in the hall and the return rate to each game machine.

Namely, in the game machines disclosed in the above Publication Nos. 6-79051 and 11-253640, the probability of generating a prize and the return rate are adjusted so as to eliminate the drawback that the player performing a large number of games is less likely to generate a prize, as is often with the conventional game machines.

Although the game machine of the above Publication No. 8-24401 has succeeded in eliminating unevenness in the probability of generating a prize, the following problem remains.

In this game machine, control of “unevenness” is performed per game machine. It is therefore impossible to eliminate imbalance between players. As a result, the player cannot enjoy the game without anxiety. For instance, one player continues a game with one game machine for a while, without receiving any prize, and then moves to other game machine. Immediately thereafter, another player who starts a game with the one game machine is more likely to get a prize, Under such circumstances, it is unavoidable that the player is in constant anxiety when continuing the game with the one game machine and when moving to another game machine. Therefore, the problem that the player is away from the game machine due to such suspense, being called “missing customers,” remains unsolved.

In the game machines of return type disclosed in the above Publication Nos. 6-79051 and 11-253640, the return is controlled per game machine. Therefore, both machines also suffer from the same drawback, and the problem of missing customers remains unsolved.

### SUMMARY OF THE INVENTION

Accordingly, it is an object of the present invention to eliminate the problem of losing customers by providing such circumstances that players can perform a game without anxiety, while enjoying amusement of the game.

The present invention has the following characteristic features: (i) a player change is detected on a game machine and, based on this detection result, the cumulative credit consumption on the game machine is controlled or managed per player; (ii) when the cumulative credit consumption of a player reaches a predetermined upper limit, a return is executed to the player; and (iii) the player can set the predetermined upper limit.

According to the present invention, the player can set the upper limit that is used as a reference for the return. It may be avoidable that the player stops the game without receiving any return because the preset upper limit value is too high. Therefore, the player can perform a game without anxiety from the stage of starting the game. At the result, the conventional problem of losing customers may be eliminated.

The above-mentioned return is executed based on a predetermined return rate or a result of a lottery for determining whether a return is to be executed,

Preferably, the predetermined return rate is determined by the upper limit that the player set.

With this configuration, the return rate is set depending on the upper limit value that is the reference for the return. Concretely, when the player sets the upper limit high, the return rate is set high. On the contrary, when the player sets the upper limit low, the return rate is set low. Therefore, the player setting the upper limit high can enjoy increased game characteristics, whereas the player setting the upper limit low can perform a game without anxiety.

Preferably, on a display part of the game machine, there may be displayed the upper limit value set to the game machine and the player's cumulative credit consumption or the rate (or ratio) of the cumulative credit consumption to the upper limit (i.e., percentage achievement to the upper limit).

In the absence of this display, the player cannot confirm the upper limit value that the player set, and the player will continue a game without being informed of when the game machine reaches the upper limit. This increases the player's anxiety. On the other hand, when the upper limit value and the percentage achievement to the upper limit are displayed, the player can continue the game without anxiety.

The present invention, advantage in operating the same and aims which is attained by implementing the present invention will be better appreciated from the following detailed description of illustrative embodiment thereof, and the accompanying drawings.

### BRIEF DESCRIPTION OF THE DRAWINGS

FIG. 1 is a diagram showing, in simplified form, the configuration of a credit return system according to one preferred embodiment of the present invention;

FIG. 2 is a perspective view showing the appearance of a game machine;

FIG. 3 is a vertical sectional view of the game machine;

FIG. 4 is a block diagram showing the electrical configuration of the game machine;

FIG. 5 is a block diagram showing the electrical configuration of a game server;

FIG. 6 is a flowchart showing the flow of control of the game machine;

FIG. 7 is a flowchart showing the flow of operation of the game machine;

FIG. 8 is a flowchart showing the flow of operation of the game machine when performing a player identification process;

FIG. 9 is a flowchart showing the flow of operation when the game server makes preparation for return;

FIG. 10 is a flowchart showing the flow of operation when the game server executes a return;

FIG. 11 is a flowchart showing the flow of operation when a player sets an upper limit value on a game machine;

FIG. 12 is a flowchart showing the flow of operation when the game server sets a return rate; and

FIG. 13 is a diagram of an example of game history tables showing the play situations of a plurality of game machines that the game server collectively controls.

### DETAILS DESCRIPTION OF THE PREFERRED EMBODIMENT

One preferred embodiment of the present invention will be described below m detail, based on the accompanying drawings.

Overall Configuration of System

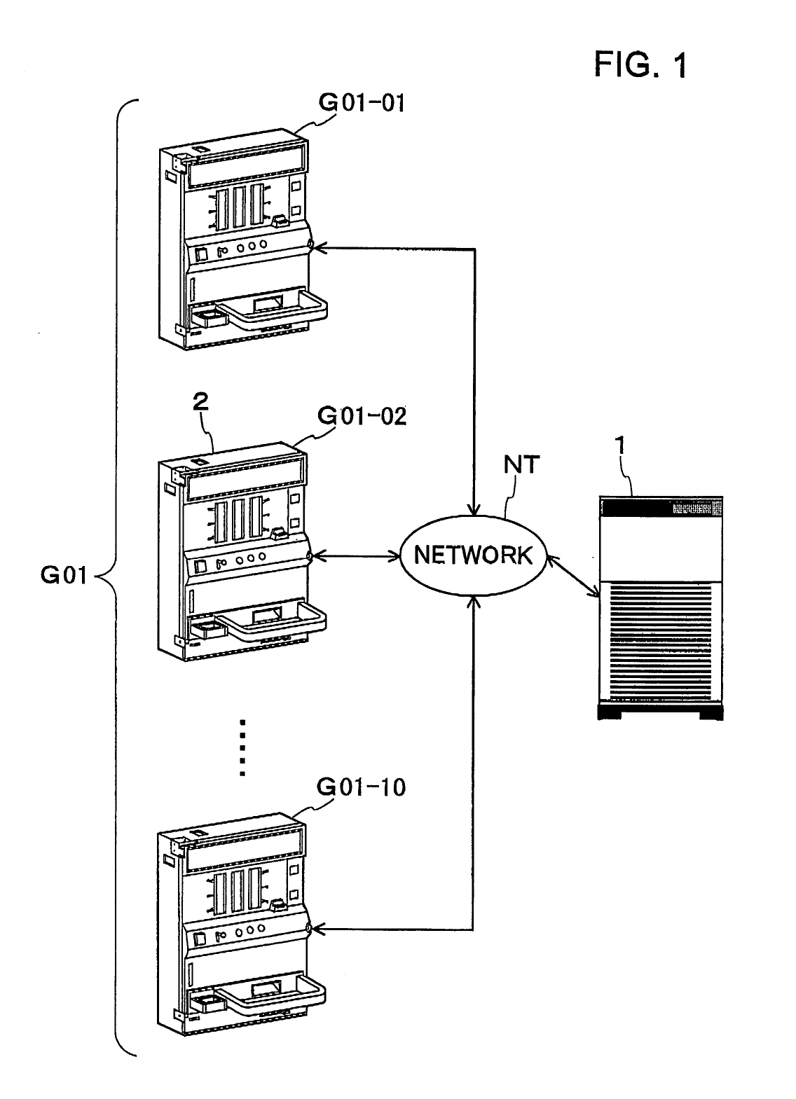

FIG. 1 is a diagram showing, in simplified form, the configuration of a credit return system according to one preferred embodiment of the invention. Referring to FIG. 1, this credit return system comprises: (i) a game server 1; and (ii) a game machine group G01 that is a collection of a plurality of game machines 2.

The game machines 2 are connected via a network NT to the game server 1 and can send to and receive from the game server 1 a variety of information via the network NT. Individual identification numbers (e.g., G01-01, G01-02, . . . G01-10) are assigned to the individual game machines 2 in the game machine group G01.

The game server 1 collectively controls the game machine group G01 is comprised of the game machines 2, and identifies or discriminates the source of data sent from the game machine group G01, based on the identification number being unique to each game machine 2. On the other hand, when the game server 1 sends data to the game machine 2, the game server 1 designates the destination (i.e., the game machine 02) of the data by using the corresponding identification number.

Data sent from and received by the game machine 2 contain: (i) the identification number being unique to the game machine; and (ii) identification information to identify the player currently playing with the game machine. Based on the identification information, the game server 1 determines whether: (i) a game is performed on the game machine 2; and (ii) there is a player change with the game machine 2.

Hereinafter, the game server is merely referred to as a “server.”

Mechanical Configuration of Game Machines

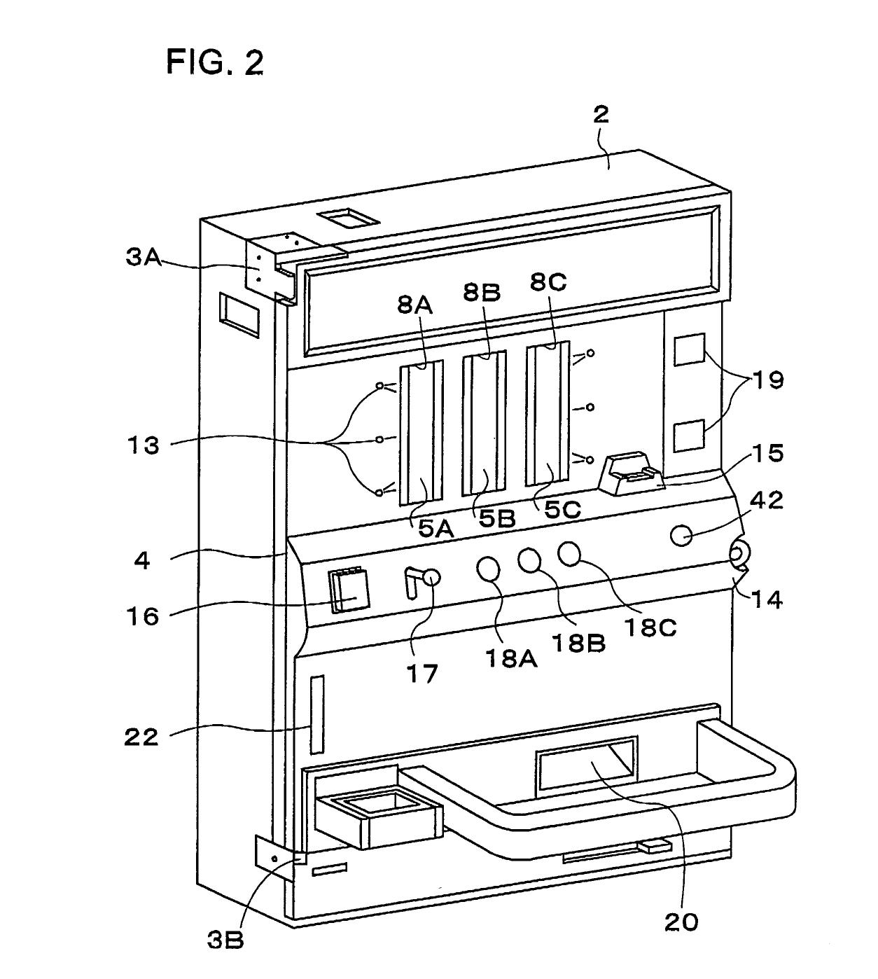

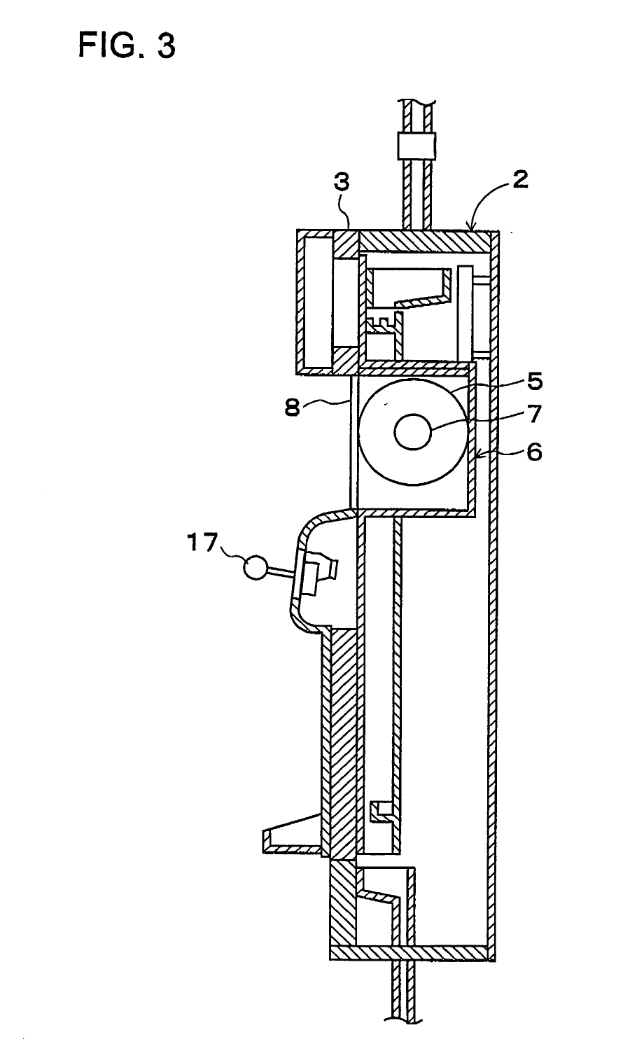

FIG. 2 is a perspective view showing the appearance of a game machine. FIG. 3 is a vertical sectional view of the game machine. Referring to FIGS. 2 and 3, a game machine 2 is a slot game machine (slot mache) and has a frame body 3.

The frame body 3 is in the shape of hollow box, A front panel 4 is attached so that it is able to open and shut to the fame body 3 via hinges 3A and 3B.

Attached to the rear surface of the front panel 4 is a casing 6, with which three rotating drums 5 (5A to 5C) arranged across the width thereof are covered from their back face.

The drums 5A to 5C are of tubular shape and are supported rotatively about rotary axes 7. Symbol marks (e.g., figure “7”, bell, plum, cherry etc.) are respectively drawn on the peripheral surfaces of the drums 5A to 5C such that the symbol marks are aligned in a row around their periphery. Of the symbol marks drawn on the peripheral surfaces of the drums 5A to 5C, one symbol mark per drum is visible from the front side of the game machine 2 via windows 8A to 8C disposed on the front panel 4.

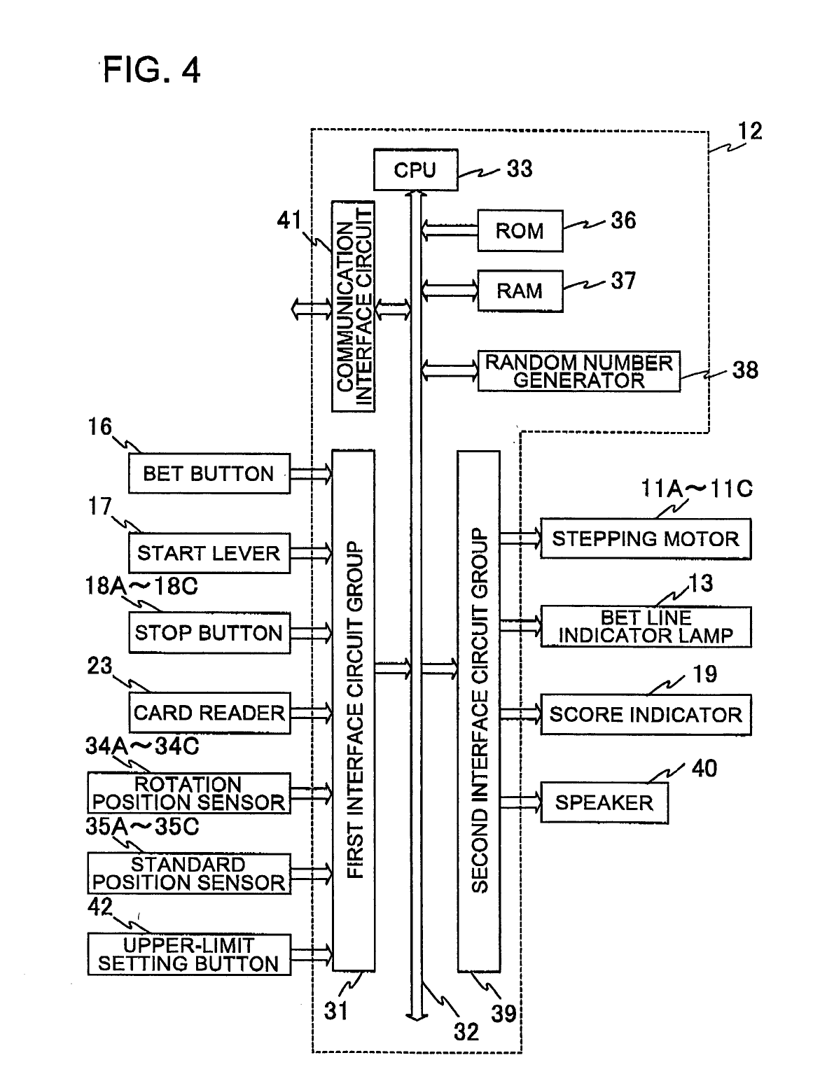

The rotary axes 7 of the drums 5A to 5C are attached rotatively via bearings (not shown) to a predetermined bracket (not shown) of the frame of the game machine 2. One ends of the rotary axes 7 are coupled to output axes of stepping motors 11A to 11C (see FIG. 4). Therefore, the drums 5A to 5C are rotatively driven by the stepping motors 11A to 11C, respectively, and controlled such that they are stopped at a predetermined rotational angle position by a control device 12 (see FIG. 4).

Projection parts (not shown) indicating a standard position are disposed on the peripheral end parts of the drums 5A to 5C. The control device 12 detects the rotational standard positions of the drums 5A to 5C when these projection parts cross the optical axes of optical sensors (not shown), which are disposed so as to correspond to the drums 5A to 5C. The rotational speed of the stepping motors 11A to 11C is set so as to make constant a speed at which symbol marks are displayed while changing.

Bet line indicator lamps 13 are disposed adjacent to the windows 8A to 8C. The lamps 13 are provided for indicating which line of plural symbol mark stop lines displayed on windows 8A to 5C has been selected as a bet object.

A control part 14 is located at approximately the mid section of the front panel 4, and a bet button 16 is disposed in the control part 14. The bet button 16 is provided for setting a bet of medals entered via a throw-in slot 15. When the player pushes the bet button 16 by the amount of medals on which the player desires to bet, the corresponding bet line indicator lamp 13 is lit up. The upper limit of bet medals is three in the game machine 2.

The bet lines are different depending on the number of times the bet button 16 is depressed. By one operation, a single line extending horizontally in the middle stage of the windows 8A to 8C is the object of bet line. By two operations, the object of bet line amounts to three lines obtained by adding two lines extending horizontally in the upper and lower stage of the windows 8A to 8C, to the above-mentioned line. By three operations, the object of bet line amounts to five lines obtained by adding two lines on the diagonal of the windows 8A to 8C, to the above-mentioned three lines, Four or more operations are invalid.

Upon setting a bet medal number according to the above-mentioned procedure, the control device 12 takes medals corresponding to the bet medal number set by the player. By taking the medals, the condition of starting slot game is established, In this state, when the player operates a start lever 17, the control device 12 rotates the drums 5A to 5C.

The control part 14 has three stop buttons 18A to 18C disposed at locations that correspond to the drums 5A to 5C, respectively. Upon depressing the stop buttons 18A to 18C, the corresponding drum is stopped.

The front panel 4 has digital score indicators 19 that indicates, for example, (i) the number of medals the player threw in for the game; and (ii) the number of medals to be discharged. When one of predetermined specific combinations of symbol marks (winning state) in the drums 5A to 5C is aligned on the stop line on which the player bets, a medal payout device (not shown) is driven to discharge a predetermined number of medals to a medal payout tray 20.

Further, the front panel 4 has a card inlet 22, through which the player inserts a card storing an identification number data to identify the player when he/she plays a game with the game machine 2. A card reader 23 (see FIG. 4) reads the data of the inserted card.

An upper-limit setting button 42 is disposed in the operation part 14. By operating this button 42, the player or the provider of the game machine 2 sets an upper limit value that is the standard for return. Depressing the button 42 to set a desired upper limit, the upper limit value is displayed on the display part 19. This upper limit preferably has such a value that the player can consume a day.

Electrical Configuration of Game Machine

FIG. 4 is a block diagram showing the electrical configuration of the game machine, Referring to FIG. 4, the control device 12 of the game machine 2 comprises: (i) first interface circuit group 31; (ii) input/output bus 32; (iii) CPU 33; (iv) ROM 36; (v) RAM 37; (vi) random number generator 38; (vii) second interface circuit group 39; and (viii) communication interface circuit 41.

The bet button 16 is connected to the first interface circuit group 31 being connected to the input/output bus 32. When the player depresses the bet button 16, an operation signal is issued from the bet button 16 to the interface circuit group 31. The interface circuit group 31 converts the operation signal to a predetermined voltage signal and provides it to the input/output bus 32. Therefore, before starting a game, a predetermined number of medals corresponding to a value indicated by the operation signal are thrown into the game machine 2 as the object of bet.

The input/output bus 32 performs input/output of data signals or address signals to the CPU 33.

The start lever 17 and stop buttons 18A to 18C are connected to the first interface circuit group 31, on which (i) a start-up signal issued from the start lever 17; and (ii) a stop signal issued from the stop buttons 18A to 18C, are converted to predetermined voltage signals and then provided to the input/output bus 32.

When the start lever 17 is operated to start a game, the start-up signal is provided to the CPU 33. Upon receiving the start-up signal, the CPU 33 issues a control signal to the stepping motors 11A to 11C in order to rotate the drums 5A to 5C.

When the stop buttons 18A to 18C are depressed to stop the drums 5A to 5C, the respective stop signals from the stop buttons 18A to 18C are provided to the CPU 33. if desired to stop the first drum 5A, the player operates the stop button 18A. If desired to stop the second drum 5B, the player operates the stop button 18B. If desired to stop the third drum 5C, the player operates the stop button 18C. Upon receiving the stop signal, the CPU 33 issues the stop signal to the stepping motors 11A to 11C, in order to stop the drum corresponding to the operated stop button.

Rotational position sensors 34A to 34C are connected to the first interface circuit group 31. The sensors 34A to 34C are disposed in the vicinity of the stepping motors 11A to 11C, respectively. The sensors 34A to 34C issue angle position signals that respectively indicate the rotational angle positions of the stepping motors 11A to 11C, to the interface circuit group 31. For example, rotary encoders are usable as the rotational position sensors 34A to 34C.

Standard position sensors 35A to 35C are connected to the first interface circuit group 31. The sensors 35A to 35C are disposed in the vicinity of the drums 5A to 5C, respectively. The sensors 35A to 35C are optical sensors as described above, and issue standard position signals to the interface circuit group 31 when detecting the standard positions of the drums 5A to 5C.

The card reader 23, which is disposed within the game machine 2, is connected to the first interface circuit group 31. The card reader 23 issues a card status signal at a predetermined timing, in accordance with a signal sending demand from the CPU 33. When a card is inserted into the card inlet 22 (see FIG. 2), for example, the signal level of the card status signal is higher than a standard level. Based on the change in signal level, the CPU 33 detects that the card is inserted. On the other hand, when no card is inserted (i.e., the state that the card has been drawn out from the card inlet 22), for example, the level of the card status signal returns to the standard level. Based on the change in signal level, the CPU 33 detects that no card is inserted.

Further, the upper-limit setting button 42 is connected to the first interface circuit group 31. When a player depresses the upper-limit setting button 42, an operational signal is issued from the button 42 to the interface circuit group 31. The interface circuit group 31 converts the operational signal to a predetermined voltage signal and supplies it to the input/output bus 32. At the result, before a game is started, a predetermined upper limit value corresponding to the operational signal is set to the game machine 2, as standard for return.

The CPU 33 detects: (i) an angle position signal issued from the rotational position sensors 34A to 34C; and (ii) a standard position signal issued from the standard position sensors 35A to 35C, thereby obtaining data of symbol marks displayed on the windows 8A to 8C.

The ROM 36 and RAM 37 are connected to the input/output bus 32. The ROM 36 stores: (i) a program for controlling the game machine and returning medals; and (ii) an initial value of variable used in the program. The ROM 36 stores data group indicating correspondence between a combination of symbol marks and random numbers. The RAM 37 stores flags and variable values.

The communication interface circuit 41 is connected to the input/output bus 32. The circuit 41 is used when performing sending/receiving of data between the game machine 2 and server 1.

The random number generator 38 for generating the above random numbers is connected to the input/output bus 32. When the CPU 33 issues an instruction for generating random numbers issued to the random number generator 38, the random number generator 38 generates random numbers in a predetermined range, and issues signals indicating the random numbers to the input/output bus 32. When a random number is issued from the random number generator 38, in order to determine a combination of symbol marks that corresponds to the random number, the CPU 33 searches the above data group and then substitutes a value corresponding to the combination to variables.

Usually either normal game or special game can be played with the game machine 2.

In the normal game, there are (i) an enabled prize-winning status that a combination of symbol marks stopped and displayed on an effective line can match a prize-winning pattern; and (ii) unabled prize-winning status that a combination of symbol marks cannot match a prize-winning pattern.

In the unabled prize-winning status, examples of symbol mark combinations that are changed on effective lines are: (i) failure pattern; and (ii) small prize pattern. The term “small prize” means that a predetermined number of symbol marks such as “cherry” and “bell” are aligned on the effective line, and a few medals are discharged to the payout tray 20. On the other hand, the term “failure pattern” means that symbol marks are not aligned on any effective line, and no medals are discharged. The unabled prize-winning status can move to the enabled prize-winning status by an internal lottery processing to be described later. In the unabled prize-winning status, any prize-winning pattern cannot be aligned irrespective of a timing at which the stop buttons 18A to 18C are depressed, Hence, it is impossible to move from the normal game status to the special play status.

On the other hand, only in the enabled prize-winning status, a combination of symbol marks stopped and displayed by a timing at which the stop buttons 18A to 18C are depressed will match a prize-winning pattern. In other words, this state allows for “aiming (observation push).” When a combination of symbol marks stopped and displayed on an effective line matches a prize-wiring pattern, the player wins a prize and the game style moves to the special game providing a chance of obtaining a large number of medals. When the player fails to obtain any prize-winning pattern by missing a timing of depressing the stop buttons 18A to 18C, the above-mentioned failure pattern or small prize pattern is aligned on the effective line. If once the enable prize-winning status is set, this status continues until a combination of symbol marks stopped and displayed matches a prize-winning pattern. There is no move to the unable prize-winning status.

In the special game, there is extremely high probability that a combination of symbol marks stopped and displayed on an effective line will match a small prize pattern. This leads to a high possibility of obtaining a large number of medals. Upon finishing the special game, the game style moves to the normal game. When the normal game is performed after the special game, the determination whether the game proceeds in the enabled prize-winning status or the unabled prize-winning status is made by an internal lottery processing to be described later.

The second interface circuit group 39 is also connected to the input/output bus 32. To the circuit group 39, there is connected: (i) stepping motors 11A to 11C; (ii) bet line indicator lamp 13; (iii) score indicator 19; and (iv) speaker 40. The circuit group 39 applies a drive signal or drive power to each of these devices. For instance, when the player depresses the bet button 16, a drive current is applied to the bet line indicator lamp 13, in order to indicate a bet line that becomes effective in accordance with the number of throw-in medals. When the game (play) is over, a drive signal is applied to the score indicator 19, in order to indicate the score corresponding to the prize-winning status. The speaker 40 issues an effect sound corresponding to the game status when the game is started or over.

Configuration of Game Server

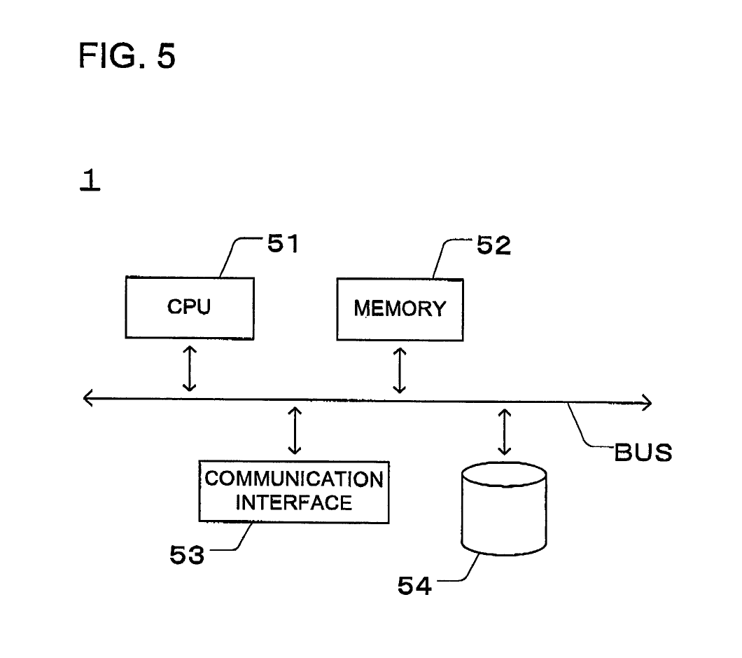

FIG. 5 is a block diagram showing the electrical configuration of the game server. Referring to FIG. 5, a server 1 has a data bus BUS. To the data bus BUS, there are connected (i) CPU 51; (ii) memory 52; (iii) communication interface 53; and (iv) database 54.

The CPU 51 executes various processing according to programs stored in the memory 52. Concretely, the CPU 51 receives data from the game machine 2 via a communication line connected by the communication interface 53, and stores the data in the memory 52, This data contains for example the upper limit data and return rate data of plural game machines 2 under the control of the server 1, that is, information sent from each game machine 2 under the control of the server 1. The CPU 51 reads a program stored in the database 54 on the memory 52, and progresses the program based on the information sent from each game machine 2 that is stored in the memory 52. The progress of the program is stored in the database 54.

Operation of Game Machine

It is assumed in the following, for purposes of description, that the game machine 2 is activated in advance, and flags and variables are initialized to a predetermined value.

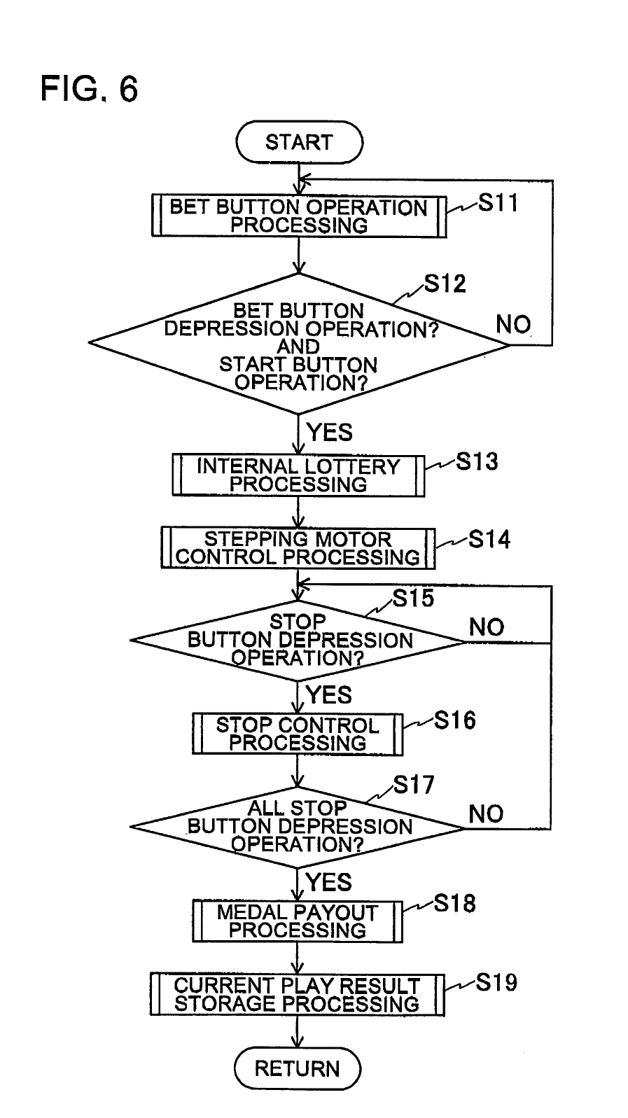

FIG. 6 is a flowchart showing the flow of control of game machines. Referring to FIG. 6, firstly, the CPU 33 with the game machines 2 judges whether the bet button 16 is depressed by the player (step S11). The bet-button operating judgment processing is executed in accordance with the operation of depressing the bet button 16, and includes the following processing: (i) detecting whether an operation signal is issued from the bet button 16 in response to an operation to the bet button 16, thereby storing the number of throw-in medals with the operation; and (ii) issuing a drive signal to the bet line indicator lamp 13, in order to indicate the bet line that becomes effective in accordance with tie number of throw-in medals.

Upon completing the bet-button operating judgment processing, the CPU 33 judges whether the pressing operation of the bet button 16 is performed and the operation of the start lever 17 is performed (step S12). When the CPU 33 judges both operations are performed, the CPU 33 moves the processing to step S13. On the other hand, when the CPU 33 judges both are not performed or none of these operations are performed, the CPU 33 returns the processing to step Sll, and performs the bet-button operation processing again. As will be described later, a period of time that all the drums 5A to 5C are started in rotation and are brought into a stop is a sequence of game (play).

Moving to the processing of step S13, the CPU 33 executes an internal lottery processing. The internal lottery processing includes processing of: (i) controlling the random number generator 38 to generate a random number; and (ii) searching data group indicating the correspondence between combinations of symbol marks and random numbers, thereby deciding a combination of symbol marks in accordance with the generated random number. As will be described later, the combination of symbol marks stopped and displayed on the previous game is stored in the RAM 37. In the following game, the CPU 33 reads the combination of symbol marks stored in the RAM 37, so that it is used for internal lottery processing.

In the internal lottery processing, a combination of symbol marks that can be stopped and displayed is determined by lottery, and a value indicating the lottery result is substituted for a lottery data of the currently performing game (current game lottery data). For instance, when it is in the unabled prize-winning status and in failure pattern, the current game lottery data is set to “00”. When it is in the unabled prize-wing status and there occurs the symbol marks combination matching with a small prize pattern, the current game lottery data is set to “01”. When it is in the enabled prize-winning status, the current game lottery data is set to “12”. When it is in the special play status and in failure pattern, the current game lottery data is set to “20”. When it is in the special play status and there occurs the symbol marks combination matching with a small prize pattern, the current game lottery data is set to “21”. In an alternative, it may be checked whether the player has moved to an advantageous state based on the stopped symbol marks, without performing any internal lottery processing.

Upon completing the processing of step S13, the CPU 33 reads a subroutine about stepping motor control processing (not shown) and issues, based on the subroutine, control signals to the stepping motors 11A to 11C, in order to drive each motor at a predetermined rotational speed (step S14). The term “rotational speed” means a speed at which the symbol marks are changeably displayed by the rotation of the drums 5A to 5C in the above-mentioned sequence of game (play), and means that any speed in the transient rotation state, such as of immediately after the drums 5A to 5C starts rotation and immediately before they are brought into a stop, are excluded from the concept of the rotational speed.

In this preferred embodiment, there is a lottery data of the game performed in the past that corresponds to the above-mentioned current game lottery data. The past game lottery data is data indicating the lottery result of the game performed before the current game, and the data is stored in the RAM 37. As will be described later, in the normal game to which the game style moves when the special game is over, the past game lottery data is reset at the time of performing the fast game. The past game lottery data is updated by sequentially accumulating the current game result in the previous game result.

Upon completing the above-mentioned stepping motor control processing, the CPU 33 judges whether the player depressed any one of the stop buttons 18A to 18C in order to stop the drums 5A to 5C, and from which stop button a stop signal is issued (step S15). When the judgment result is that no stop signal is issued from the stop buttons 18A to 18C, the CPU 33 executes again the processing of step S15. On the other hand, when the judgment result is that a stop signal is issued from any one of the stop buttons 18A to 18C, the CPU 33 performs processing for stopping the stepping motors 11A to 11C (step S16). This stepping motor stop control processing includes: (i) controlling the random number generator 38 to generate a random number; and (ii) searching data group indicating the correspondence between combinations of symbol marks and random numbers, thereby deciding a combination of symbol marks in accordance with the generated random number.

The CPU 33 obtains symbol marks currently appearing on the windows 8A to 8C, based on (i) a rotational position signal issued from the rotational position sensors 34A to 34C; and (ii) a standard position signal issued from the standard position sensors 35A to 35C. Upon obtaining the symbol marks, the CPU controls the stepping motors 11A to 11C and decides a stop position, based on (i) the above-mentioned symbol mark data, and (ii) the current game lottery data set in the above-mentioned internal lottery processing (step S13).

Although the CPU 33 stops the stepping motors 11A to 11C in accordance with the current game lottery data, if decided that arty one of the stop buttons 18A to 18C is depressed, the CPU 33 can apply an additional drive to the stepping motors 11A to 11C, under prescribed conditions. Concretely, when any symbol mark corresponding to the current game lottery data cannot be stopped and displayed, the stepping motors 11A to 11C are subject to an additional drive in the range of the maximum amount of four symbol marks. In this connection, if any symbol mark corresponding to the current game lottery data is not present in that range, it is impossible to stop and display any symbol mark corresponding to the current game lottery data. For instance, even when in the enabled prize-winning status, two dams are already stopped and there is a symbol mark(s) allowing for match with a winning pattern, whether the player obtains the winning pattern depends on the timing at which the player operates the stop button corresponding to the last drum to be stopped. On the other hand, when in the unabled prize-winning status, two drums are already stopped and there is a symbol mark(s) allowing for a winning pattern, the stepping motors 11A to 11C are controlled so as not to provide a match with the winning pattern, irrespective of the timing of operation of the stop button corresponding to the last drum to be stopped.

Upon completing the above-mentioned stepping motor stop control processing, the CPU 33 judges whether all the stop buttons 18A to 18C are depressed (step S17). In other words, in the processing of step S17, it is judged whether there are detected all the stop signals issued in accordance with the depressing operation to the stop buttons 18A to 18C. In this connection, when the judgment result is that all of the stop buttons 18A to 18C are not operated, the CPU 33 returns the processing to step S15. On the other hand, when the judgment result is that all the stop buttons 18A to 18C are operated, the CPU 33 moves the processing to step S18.

Moving to the processing of step S18, the CPU 33 judges whether a combination of symbol marks aligned on the line that becomes effective matches with a winning status, and pays out game medals corresponding to the winning status (step S18). When the judgment result is that (i) the combination of symbol marks aligned in the effective line and (ii) the wining state are each matched, the CPU 33 calculates the number of payout medals corresponding to the winning status, and payouts a number of medals corresponding to the calculated number. Thereafter, the CPU 33 moves the processing to step S19. On the other hand, when the judgment result is that the combination of symbol marks aligned in the effective line and the wining state are not matched, the CPU 33 moves the processing to step S19, without executing any medal payout.

Moving to the processing of step S19, the CPU 33 mainly stores the current game lottery data (step S19). In this preferred embodiment, the present subroutine is terminated at the time that the CPU 33 read a past game lottery data from the RAM 37 and stored the current game lottery data together with the read past game lottery data in the RAM 37. At this time, for example, data indicating the actually stopped and displayed symbol marks in the present game is also stored in addition to the present game lottery data.

Description will next be made of the operation of a game machine 2 of this preferred embodiment when performing a game with the game machine 2.

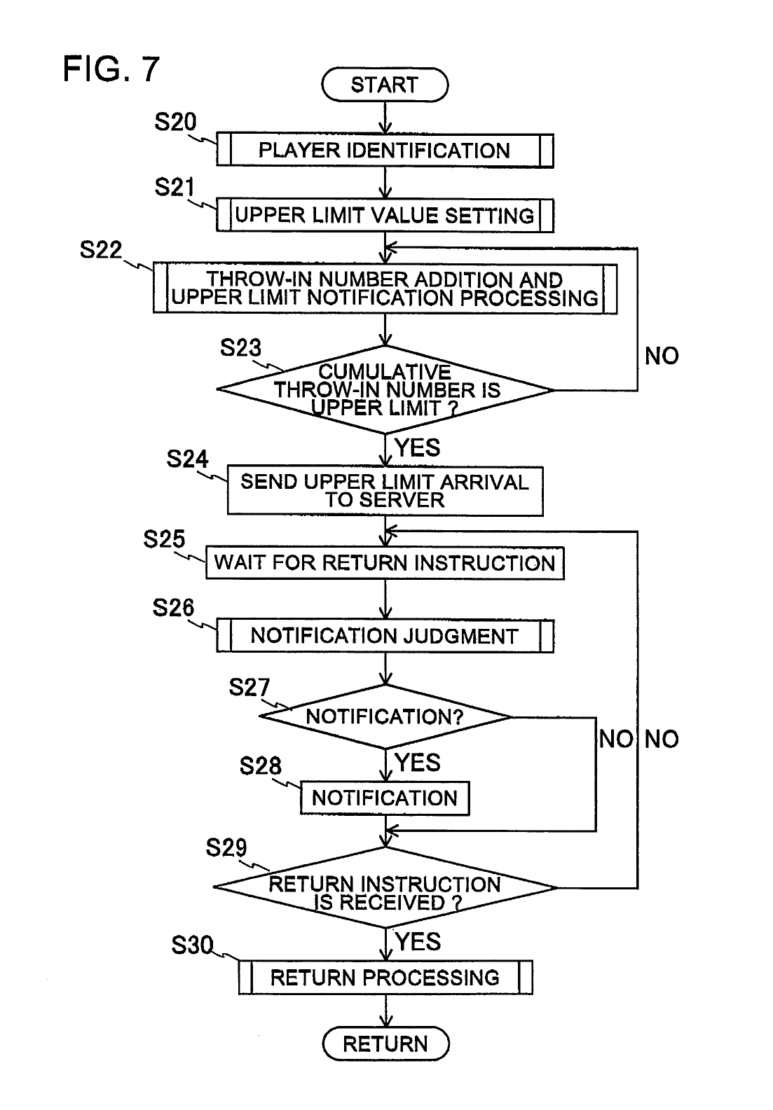

FIG. 7 is a flowchart showing the flow of operation of game machines. The procedure shown in this flowchart is performed concurrently with the subroutine of the game machines 2 shown in FIG. 6.

Referring to FIG. 7, the game machine 2 discriminates the player (step S20). This player discrimination processing is performed to judge as to: (i) whether a game is being performed on the game machine 2; (ii) who the player is, if a game is performed on the game machine 2; and (iii) whether he/she is the same as or different from the previous player.

The reason why the player identification (discrimination) processing is particularly necessary is that a return is executed per player in this preferred embodiment, unlike the conventional game machine executing a return per game machine. That is, when there is a player change, the play status about the upper limit till then is reset. It is therefore necessary to detect a player change and identify (discriminate) the player.

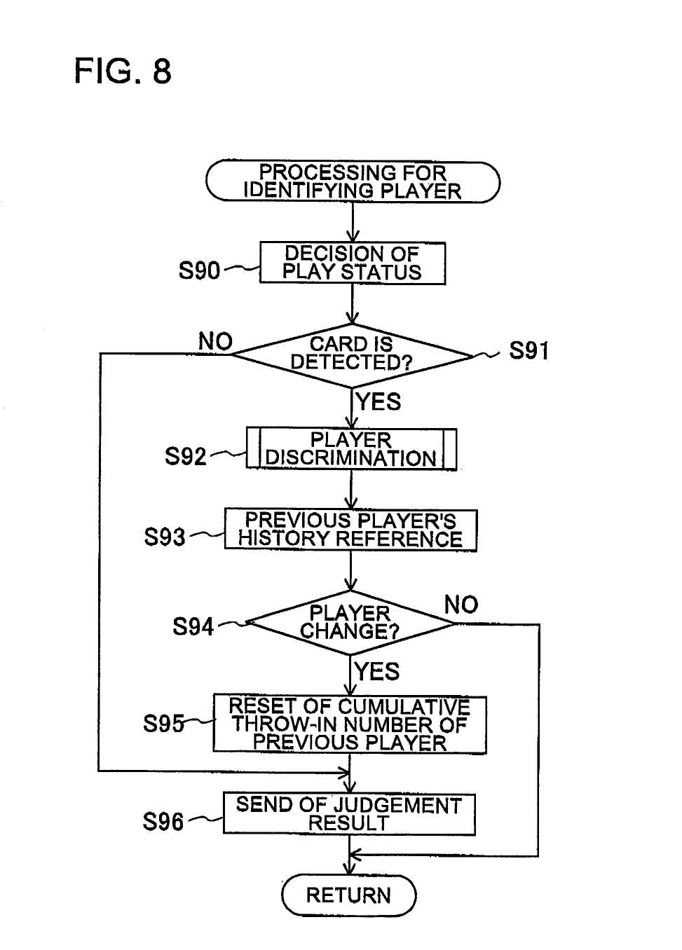

FIG. 8 is a flowchart showing the flow of operation when a game machine identifies or discriminates the player. This flowchart corresponds to the subroutine of the player discrimination processing (step S20) shown in FIG. 7.

Referring to FIG. 8, firstly the CPU 33 with game machine 2 judges play status (step S90). The play status judgment is processing for judging whether there is a player performing a game on the game machine 2 (i.e., whether a game is being performed on the game machine 2). When the game machine 2 is not in play status, the following processing is unnecessary. It is therefore necessary to firstly check whether the game machine 2 is in play. The play status judgment is achieved by detecting whether a card is inserted into the card inlet 22 provided on the front panel 4 of the game machine 2.

In order to check the play status, the CPU 33 judges whether a card is detected (step S91). This card detection is achieved by detecting whether a card is inserted into the card inlet 22 with the card reader 23. The card to be inserted is an identification card storing information to identify the player, which can have any function other than identification. For example, a card (e.g., a prepaid card) storing information to identify the player can be used.

In step S91, the card detection is performed. At the result, when the judgment result is that no card is inserted, the CPU 33 terminates the player discrimination (identification) processing. Thereafter, the CPU 33 sends the server 1 a signal of discrimination result that no card is detected (step S96). As the contents of signals related to the card detection, for example, data “0” is sent when no card is detected, and data “1” is sent when a card is detected.

On the other hand, when the judgment result is that a card is inserted, the CPU 33 identifies the player performing a game on the game machine 2 (step S92). If a card is already inserted, the card reader 23 reads information stored in the card. In this preferred embodiment, the card inserted in the card inlet maintains identification number data individual to the player, in order to identify the player. Therefore, the CPU 33 identifies the player performing a game on the game machine 2, based on the identification number data.

Upon completing the above-mentioned player identification processing, the CPU 33 refers to the previous player's history (step S93). Information of the players who have been played on the game machine 2 is stored, as history, in the RAM 37 of the game machines 2. The CPU 33 refers to the player's history stored in the RAM 37, and refers to the identification number of the player immediately before receiving a signal indicating that a card has been detected.

Upon completing tile reference to the immediately-before-player history, the CPU 33 judges whether there is player change (step S94). The CPU 33 compares (i) the identification number data of the previous player that has been referred to in step S93; with (ii) the identification number data of the player that has been sent from the card reader 23 together with the card detection signal, thereby judging whether there is agreement between the two. If the two data agree, the CPU 33 judges that there is no player change, because the same player merely inserted the identification card again. If the two data are different, the CPU 33 judged that there is player change. In the absence of no player change, the CPU 33 completes the player discrimination processing. On the other hand, in the presence of player change, the CPU 33 resets the cumulative throw-in number of the previous player (step S95). Concretely, the CPU 33 resets data related to the cumulative throw-in number of credit consumed by the previous player, in the player's history stored in the RAM 37 that has been referred to in step S93.

This reset processing is for implementing one of the characteristic features of this preferred embodiment, that is, performing a “return” per player. This means that the cumulative throw-in number of credit cannot be increased by addition to the credit number thrown by the other player. Therefore, if a certain player stops a game on one game machine before reaching the upper limit of the cumulative throw-in number of credit, and moves to the other game machine, this player will start a game on the other game machine from the status that the cumulative throw-in number of credit returns to “0”. Thereby, the player might not often change game machines. In addition, the player is aware that there is a high probability of return when reaching the upper limit of the cumulative throw-in number. This makes it possible to continue the game without anxiety.

Upon completing the above-mentioned reset processing, the CPU 33 with the game machine 2 sends the result of judgment made in step S90 (step S96). Concretely, the CPU 33 sends the player's information to the server 1 via the communication interface circuit 41, network NT, and communication interface 53 of the server 1. Data to be sent may be the player's information to which value “1” is appended, as stated above. At this time, in the CPU 33, the past player's history information stored in the RAM 37 is rewritten to the new player's information and then stored.

Upon completing the judgment result sending processing, the CPU 33 repeats the player discrimination processing.

Although in this preferred embodiment, an identification card storing data to verify the player or an ID card is used as means for identifying or discriminating the player, the following means are applicable. For example, a human sensor to detect human body may be attached to the game machine 2. To a stool on which the player sits for performing a game, the function of weighing may be added for weighing and storing the player's body weight, thereby discriminating the player.

Referring again to FIG. 7, upon completing the above-mentioned sequence of player identification (discrimination) processing, the CPU 33 with the game machine 2 sets an upper limit value that is a standard for return (step S21). The upper limit value is the number of medals, as a game medium, which is used for performing a game on a slot game machine etc. When the number of medals used by a certain player reaches the upper limit value, the slot game machine executes a return to this player.

The above-mentioned upper limit value setting is attainable in the following various instances: (i) the upper limit setting is performed by using a preset upper limit value; (ii) the owner of the game machine performs the upper limit setting; or (iii) the upper limit value is automatically changed depending on the play status. The upper limit value setting executable in the above various instances is to be performed when the game player of the game machine 2 is changed, and after referring to the result of judgment whether there is a player change in step S21. The result of judgment whether there is player change is made into data and sent from the server 1 to the game machine 2. Concretely, in the presence of player change, data to which value “1” is appended is sent. On the other hand, in the absence of player change, data to which value “0” is appended is sent.

Following is the style of using a preset upper limit value, which is one of the above-mentioned various styles. The style of setting an upper limit value by the operation of a player will be described hereafter.

The preset upper limit value is stored in the RAM 37. The CPU 33 reads data of the upper limit value from the RAM 37 and completes setting of the upper limit value.

Upon completing the above-mentioned upper limit value set processing, the CPU 33 performs, based on the result of the bet button operation processing (step S11) shown in FIG. 6, processing for (i) adding the number of medals thrown by the player as a game medium; and (ii) notifying the upper limit (step S22).

A description of throw-in number addition processing will be presented here. A medal sensor (not shown) provided within the game machine 2 counts medals thrown in through the throw-in slot 15. The counted number data is added to a cumulative throw-in number data, which is data of medals thrown in the past, and stored as a current throw-in medal data. Hereinafter, the cumulative consumption of credit is referred to as a “cumulative throw-in number of medals.”

The above-mentioned cumulative throw-in number data is data stored in the RAM 37. The CPU 33 executes the following processing for reading data of the past throw-in medal from RAM 37; adding data of the current throw-in medal counted by the medal sensor to data of the cumulative throw-in number; and storing the result of addition as updated cumulative throw-in number data in the RAM 37. The cumulative throw-in number data is reset in the presence of player change, as previously described in the player discrimination processing.

A description of upper limit notification processing will next be presented. The upper limit notification means to notify the player how soon the game machine 2 can reach the upper limit. Specific contents of the notification include; (i) the set upper limit value; (ii) the current cumulative throw-in number; or (iii) the rate of the cumulative throw-in number to the upper limit value (i.e., one that is expressed by percentage how close to the upper limit).

By virtue of this notification, the player can know to what extend he/she has to perform a game up to the upper limit. Therefore, the player can continue the game without anxiety.

Upon completing the above-mentioned throw-in medal number addition processing and upper-limit notification determination processing, the CPU 33 judges whether the cumulative throw-in number reaches the upper limit (step S23). This judgment is achieved by comparing (i) the cumulative throw-in number data that was stored in the RAM 37 in step S22; and (ii) the upper limit value that was set in step S21. Concretely, the CPU 33 compares these two data stored in the RAM 37 and judges whether the number of medals that the play throws in the game machine 2 reaches the upper limit. When the judgment result is that the cumulative throw-in number does not reach the upper limit value, the CPU 33 returns the processing to step S22, and continues processing for adding the number of medals that the player throws in the game machine 2. On the other hand, when the judgment result is that the cumulative throw-in number reaches the upper limit value, the CPU 33 notifies the player of the arrival at the upper limit, and sends the upper limit arrival result to the server 1 (step S24). Concretely, the CPU 33 sends (i) a signal indicating that the cumulative throw-in number reaches the upper limit value; (ii) data of the upper limit value set in step S21; and (iii) data of return rate to be described later, to the server 1 via the communication interface circuit 41 of the game machine 2.

The signal indicating arrival at the upper limit is expressed for example by numerical value of “1”. To the signal indicating that the cumulative throw-in number data reaches the upper limit, a signal designating the game machine 2 is appended (i.e., data indicating to which of plural game machines under the control of the server 1 the game machine 2 corresponds). For example, if an identification number, the numbers “123”, is assigned to the game machine 2 among plural game machines under the control of the server 1, a signal of “123-1”, wherein the numerical value “1” as the signal indicating arrival at the upper limit is affixed to the identification number “123” of the game machine 2, is sent to the sever 1.

The upper limit value data is stored in the RAM 37, as described above. This upper limit value data is used for determining the number of return medals on the occasion where a return must be executed to the player. The number of return medals is calculated by multiplying the upper limit value by a return rate.

The RAM 37 with the game machine 2 stores return rate data for determining to what extent the return is to be executed with respect to the upper limit value of the game machine 2 at the arrival at the upper limit. This return rate data is sent from the game machine 2 to the server 1.

Upon completing the upper-limit-arrival result sending processing to the server 1, the CPU 33 waits for a return instruction (step S25). The return instruction is a signal to be sent from the server 1 to the game machine 2 of which cumulative throw-in number data reaches the upper limit, and this signal is used for controlling the timing of return etc. The game machine 2 allows the player to perform a game even when waiting for the return instruction.

In the above-mentioned return instruction waiting status, the CPU 33 judges whether notification should be executed or not (step S26). The term “notification” means to notify that a return will be executed from now to the player of the game machine 2.

By referring to the data stored in the RAM 37, the CPU 33 determines as to whether this notification should be executed (step S27). “The RAM 37 stores data for determining execution of notification. Concretely, data of “1” is assigned for execution of notification, and data of “0” is assigned for no execution of notification. These data may be preset or set properly by the owner of the game machine etc.

When the data stored in the RAM 37 is “1”, the CPU 33 notifies the player the content that the cumulative throw-in medal number of the game machine 2 on which he/she is performing a game will reach the upper limit thereby to execute a return shortly (step S28). This notification may be executed by using an illuminator provided within the game machine 2. Alternatively, the game machine 2 may have a display part performing notification to the player. Any notification means capable of giving the player a previous notice of return may be employed, whether it be provided unitary with the game machine 2.

When the above-mentioned notification processing is completed, or when judged no notification is executed, the CPU 33 judges whether a return instruction is received (step S29). This return instruction is one that the game machine 2 waits for its arrival from the server 1 in step S25. The server 1 sends this return instruction without fail to a game machine 2 employing the style that a return is executed every time the game machine 2 reaches the upper limit, as well as a game machine 2 employing the style that a return is not always executed to the game machine 2 when it reaches the upper limit.

The server 1 sends a return instruction signal at a predetermined timing to the game machine 2 via the communication interface 53. In the game machine 2, the CPU 33 receives the return instruction via the communication interface circuit 41 and input/output bus 32. If failed to receive the return instruction, the CPU 33 returns the processing to step S25, and waits for the return instruction again.

Upon completing the above-mentioned return instruction receiving processing, the CPU 33 executes return processing (step S30). This return processing is executed based on the return instruction issued from the server 1 in step S29: Concretely, the CPU 33 receives data that indicates to what extent the return should be executed to the game machine 2, and executes a return based on the received data.

In the game machine 2 employing the style that a return is executed every time the throw-in medal number reaches the upper limit, a number of medals are returned which is calculated mainly based on the upper limit data and return rate data stored in the RAM 37. On the other hand, in the game machine 2 employing the style that a return is not always executed when the throw-in medal number reaches the upper limit, if decided to execute no return, the throw-in number data stored in the RAM 37 is reset as required. The CPU 33 executes this throw-in number data reset under a program stored in the ROM 36.

Upon completing the above-mention return processing, the CPU 33 moves again the processing to the upper-limit value setting processing (step S21), and repeats the above-mentioned sequence of processing.

Operation of Game Server

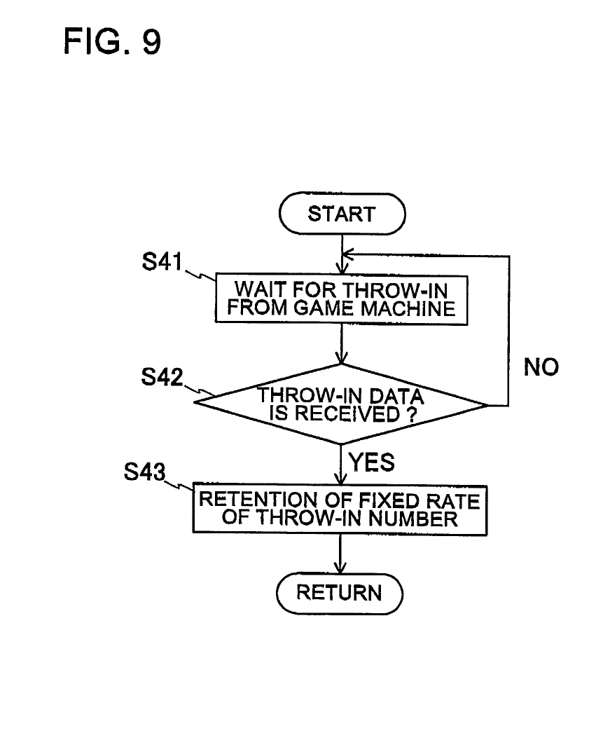

FIG. 9 is a flowchart showing the flow of operation when the game server makes preparation for return. This operation is always repeated in the server 1.

The server 1 always holds some of medals serving as a game medium, which have been thrown in each game machine 2, in preparation for execution of return to the game machine 2 under the control of the server 1 reaches the upper limit.

Referring to FIG. 9, the CPU 51 with the server 1 waits for the game medium throw-in result from each game machine 2 (step S41).

As the game medium that the player uses on each game machine 2, it is possible to use any tangible matters, e.g., medals, winning balls, or coins, each being used generally. Besides these, any intangible matters that can be expressed in numerical value as data are also handled as a game medium in this preferred embodiment. The term “throw-m” means the following action that a certain player makes a game machine recognize the game medium for the purpose of playing a game, irrespective of the type of the game medium. Therefore, not only a medal etc. that is thrown in through the throw-in slot 15 and detected by the medal sensor of the game machine 2, but also numerical value data etc. that the player decides to use for game becomes a candidate for wait.

In the status that the server 1 is waiting for throw-in of a game medium, the CPU 51 judges whether game medium throw-in data is received at a predetermined timing (step S42). In this preferred embodiment, medals are used as the game medium, and the player continues the game on the game machine 2, while throwing in medals via the throw-in slot 15. The medal sensor with the game machine 2 detects the number of thrown-in medals. The detected number is made into a numerical value as data. his data is then stored in the RAM 37 of the game machine 2, as cumulative throw-in number data. This cumulative throw-in number data is sent at a predetermined timing to the server 1 via the communication interface circuit 41. The server 1 receives this cumulative throw-in number data via the communication interface 53. The received cumulative throw-in number data is properly stored in the memory 52, based on an instruction of the CPU 51. When the judgment result in step 42 is that no throw-in data is received, the CPU 51 returns the processing to step S41.

Upon completing the throw-in data receiving judgment processing, the CPU 51 holds a predetermined rate of the throw-in number (step S43). As stated above, the server 1 is constructed so as to hold in advance the game medium for return to the player performing a game on each game machine 2 under the control of the server 1. The hold amount differs from one server to another. The hold amount is determined by multiplying the cumulative throw-in number data of each game machine 2 that the server 1 receives in step S42, by a predetermined rate (return rate).

In the above-mentioned hold processing, the server 1 sends a numerical value data corresponding to the hold amount calculated by the CPU 51, to the game machine 2 via the communication interface 53. On the game machine 2, based on the received numerical value data, the CPU 33 directs the RAM 37 to store, as hold data, a numerical value data that is part of the cumulative throw-in number data.

Upon completing the above-mentioned hold processing, the CPU 51 returns the processing to the throw-in data waiting processing (step S41), and repeats the foregoing sequence of processes.

A description will next be made of the operation when the server 1 executes a return to the game machine 2 under control of the server 1.

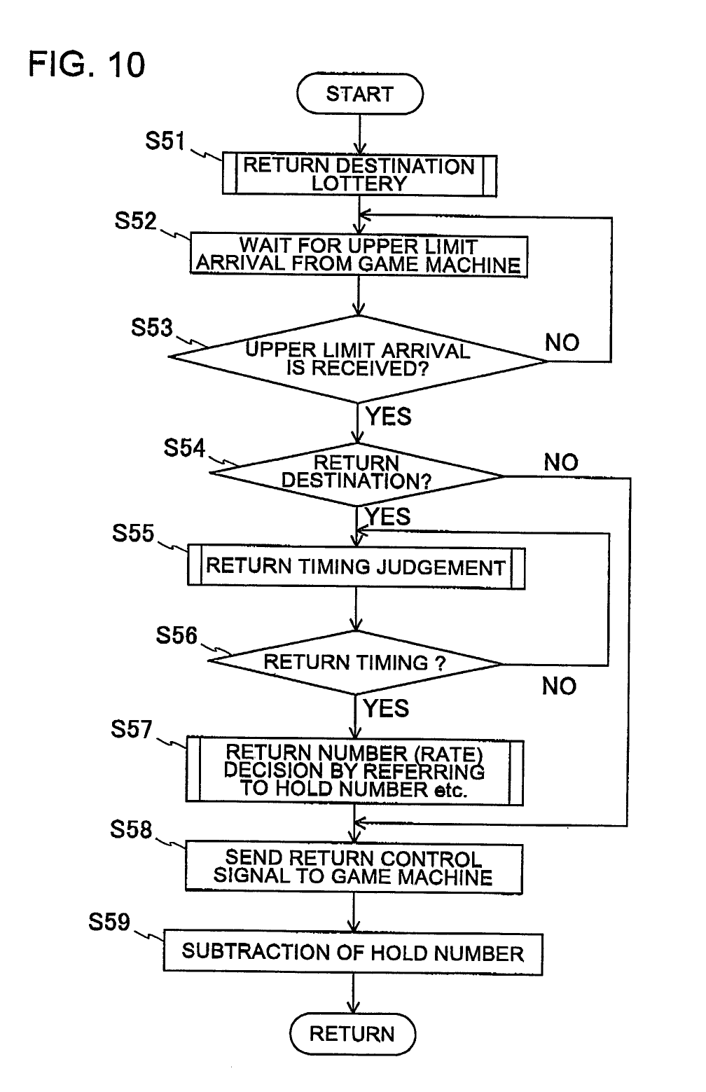

FIG. 10 is a flowchart showing the flow of operation when the game server executes a return. This operation is always repeated.

Referring to FIG. 10, firstly, the CPU 51 with the server 1 performs a lottery for determining a return destination (step S51). This return destination lottery is mainly performed to the case of taking the style that a return is not necessarily executed to the game machine 2 that has reached the upper limit. As the lottery manner, there are for example: (i) “a return is executed to a game machine that will be the N-th to reach the upper limit”; and (ii) “a return is executed to a game machine, the end of which machine-number meets a lottery-number.” Whereas in the case of taking the style that a return is always executed to the game machine reaching the upper limit, the result obtained by lottery can be exemplified as follows: (i) “a return is executed to a game machine that will be the fast to reach the upper limit; and (ii) “a return is executed to game machines, the end of which machine-number is 0, 1, . . . 9 (i.e., to designate all the machine-numbers).” These lottery results are stored in the memory 52, based on an instruction of the CPU 51.

Upon completing the above-mentioned return destination lottery processing, the CPU 51 waits for the upper limit arrival result sent from each game machine 2 (step S52). As stated above, this upper limit arrival result indicates that the game medium thrown in the game machine 2 reaches a preset amount. Upper limit arrival judgment is made on the game machine 2. At the result, when the judgment result is the arrival at the upper limit, this result is sent to the server 1 waiting for the upper limit arrival result via the communication interface 53.

When the server 1 is waiting for the upper limit arrival result, the CPU 51 judges whether it received the upper limit arrival result at a predetermined timing (step S53). The CPU 51 executes this judgment. When the judgment result is that the upper limit arrival result is received, the CPU 51 moves the processing to the step S54. On the other hand, the judgment result is that any upper limit arrival result is not received, the CPU 51 returns to the upper limit arrival result wait processing (step S52), and repeats judgment of the receipt of the upper limit arrival result at the predetermined timing.

Moving to the processing of step S54, the CPU 51 judges whether the game machine 2 sending the upper limit arrival result is a return destination. This judgment is made based on the data determined by the data obtained in the lottery in step S51. Concretely, the CPU 51 refers to the data stored in the memory 52; and judges whether it is the return destination by comparing (i) this reference data and (ii) data affixed to the upper limit arrival result.

For example, when the lottery result is that “a return is executed to a game machine, the end of which machine-number meets a lottery number,” as described above, the CPU 51 reads data of the identification number of the game machine 2 that is affixed to the above lottery result, and then judges whether the end of the identification number meets the above lottery number. In the case of taking the style that a return is always executed for the upper limit arrival, a positive result is always obtained in the judgment whether it is the return destination.

When the judgment result is negative, a signal indicating no execution of return is sent in the processing for sending a return control signal that will be described later. This signal is sent to the game machine 2 via the communication interface 53, based on an instruction of the CPU 51.

Upon obtaining a positive result in the above-mentioned return destination judgment processing, the CPU 51 judges a return timing (step S55).

The return tuning can be set variously. There is for example the following styles: (i) to the game machine reaching the upper limit and being the return destination, a forced return is executed immediately after all the processes on the server 1 are terminated; and (ii) a return is executed after an elapse of a predetermined period of time from the termination of all the processes on the server, or after performing a predetermined number of games.

The processing for judging a return timing is to judge at which timing a return should be executed. If a return timing is predetermined uniquely, this return timing is employed.

Upon completing the above-mentioned return timing judgment processing, the CPU 51 judges whether a return tog is established (step S56). The term “return timing” is one that is determined in the processing of step S55, and this return timing is stored in the memory 52 with the server 1. For instance, if provided a temporal timing such as “at a few minutes after the upper limit arrival,” a timer (not shown) within the server 1 is used to control this timing. If provided a timing based on the player's game circumstances such as “when the player performs twenty games after reaching the upper limit,” various sensors within the game machine 2 are used to judge whether predetermined conditions are satisfied. When the conditions are satisfied, a signal indicating this timing is sent from the CPU 33 with the game machine 2 to the server 1, in order to notify the incoming of the return timing.

When the judgment result is that no return timing is established, the CPU 51 returns the processing to step S55, and repeats the processing from step S55. On the other hand, when the judgment result is that the return timing is established, the CPU 51 refers to the game medium amount (number) etc. held in step S43 (see FIG. 9) and determines the amount of return based on the reference result (step S57).

The amount of return to the game machine 2 is to be managed by the game media held in step S43. Arriving at the upper limit, a return is usually executed by multiplying the upper limit value by a preset return rate. As a general rule, the CPU 51 calculates the return amount based on the upper limit data and return rate data that are contained in the upper limit arrival result sent from the game machine 2.

Upon completing the above-mentioned return amount determination processing, the CPU 51 sends a return control signal to the game machine 2 (step S58). This return control signal can be classified into two types, according to the result of the above-mentioned return destination judgment processing (step S54). Concretely, with respect to a game machine 2 that was judged as the return destination in step S54, the value of “1”, which is data indicating that this game machine 2 is the return destination, is affixed to part of a return control signal. On the other hand, with respect to a game machine 2 that was not judged as the return destination, the value of “0”, which is data indicating that this game machine 2 is not the return destination, is affixed to part of a return control signal. In the case of taking the style that a return is always executed to the game machine reaching the upper limit, the value of this return control signal is set to “1”.

The return control signal contains data indicating the degree (amount) of return. All the data contained in this return control signal are sent via the communication interface 53, based on an instruction of the CPU 51.

Upon completing the above-mentioned control signal sending processing, the CPU 51 subtracts a hold number (step S59). The term “hold number” means the game medium number held in the memory 52 with the server 1 in step S43 shown in FIG. 9. This hold game medium is used for return to each game machine 2. It is therefore necessary to perform subtract processing of the game medium number data corresponding to the return amount.

The hold number data is updated and stored in the memory 52 by the hold number subtraction processing.

In the case of changing the return amount to a game machine 2 depending on the play status, there may be configured such that when the return to the game machine 2 is completed, the CPU 33 with the game machine 2 sends the server 1 data indicating the return amount to the player and subtraction processing is started after receiving this data.

Upon completing the above-mentioned hold number subtraction processing, the CPU 51 returns the processing to step S51, and resumes the processing from the return destination lottery and later processing.

Following is the processing for setting an upper limit value by the player's operation.

Processing for setting upper limit value

As stated above, when the cumulative credit consumption of a player reaches a predetermined upper limit in the individual game machines under collective control of the game server, a return is executed as a general rule. At this time, if the predetermined upper limit as standard for return is too high, the return is less likely to occur, Therefore, the player might give up the game. On the other hand, if the predetermined upper limit is too low, the game machine is poor in game characteristics. To overcome these drawbacks, a predetermined upper limit value as standard for return can be set by the player's operation in this preferred embodiment.

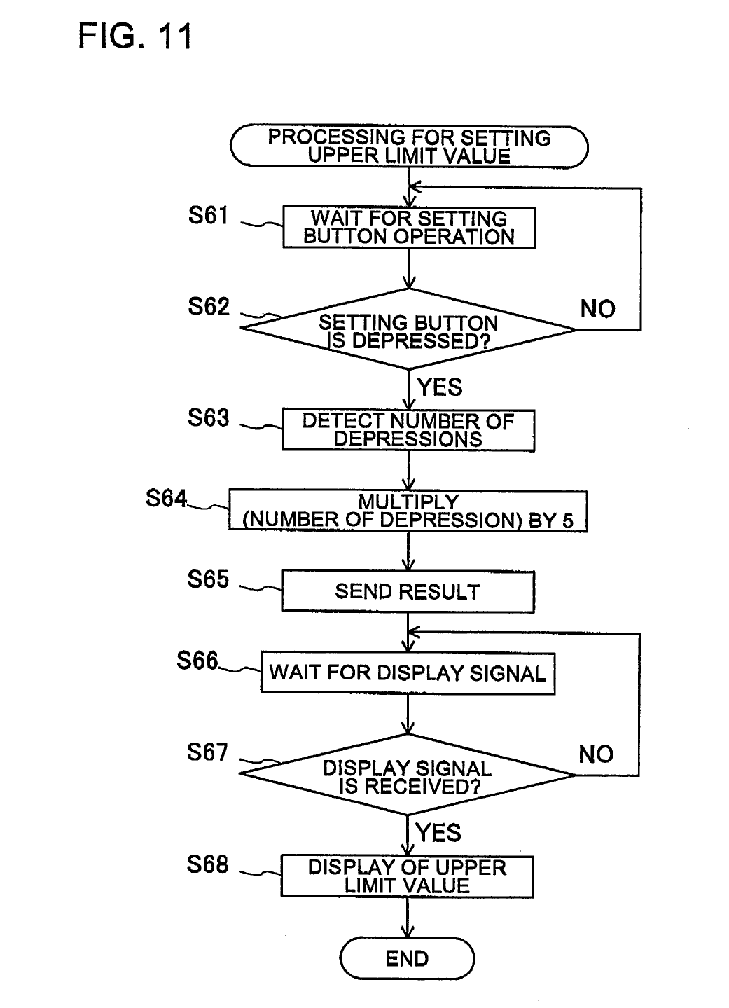

FIG. 11 is a flowchart showing the flow of operation when a player sets an upper limit value on a game machine. This flowchart corresponds to the subroutine of the upper limit setting processing in step S21 shown in FIG. 7. The processing shown in FIG. 11 is performed on the game machine 2 under collective control of the server 1.

Referring to FIG. 11, the CPU 33 with the game machine 2 firstly waits for the operation of the upper-limit setting button 42 (step S61).

As described above, the player performing a game on the game machine 2 depresses the upper-limit button 42 to set an upper limit value. The upper limit value changes depending on the number of depressions, as will be described later.

At a predetermined timing, the CPU 33 judges whether the upper-limit setting button 42 is depressed (step S62). When the judgment result is that the upper-limit button 42 is not depressed, the CPU 33 returns the processing to step S61 and waits for the button depression by the player of the game machine 2. On the other hand, when the judgment result is that the upper-limit setting button 42 is depressed, the CPU 33 detects the number of depressions (step S63). The button 42 issues a signal corresponding to the depression operation. The CPU 33 receives this signal to detect the number the player depressed the button 42, The detected depression number is then stored in the RAM 37.

Upon completing the depression number detection, the CPU 33 moves to the processing for calculating the upper limit value based on the following arithmetic expression (step S64):

Upper limit value=(Number of upper-limit setting button depressions)×5

The depression number of the upper-limit setting button 42 that is detected in step S63 is used for setting an upper limit value. In this preferred embodiment, the upper limit value that the player set is indicated at the result obtained by multiplying the depression number by 5 (in thousands of yen). The processing for calculating the upper limit value is executed under a program stored in the ROM 36.

In this preferred embodiment, the aforesaid numerical value by which the depression number is multiplied, “5”, is for purpose of illustration only and is not to be construed as a limiting value.

Upon completing the upper-limit calculation processing (i.e., calculation from the expression of (Number of upper-limit setting button depression)×5)), the CPU 33 sends the result from the arithmetic expression (step S65).

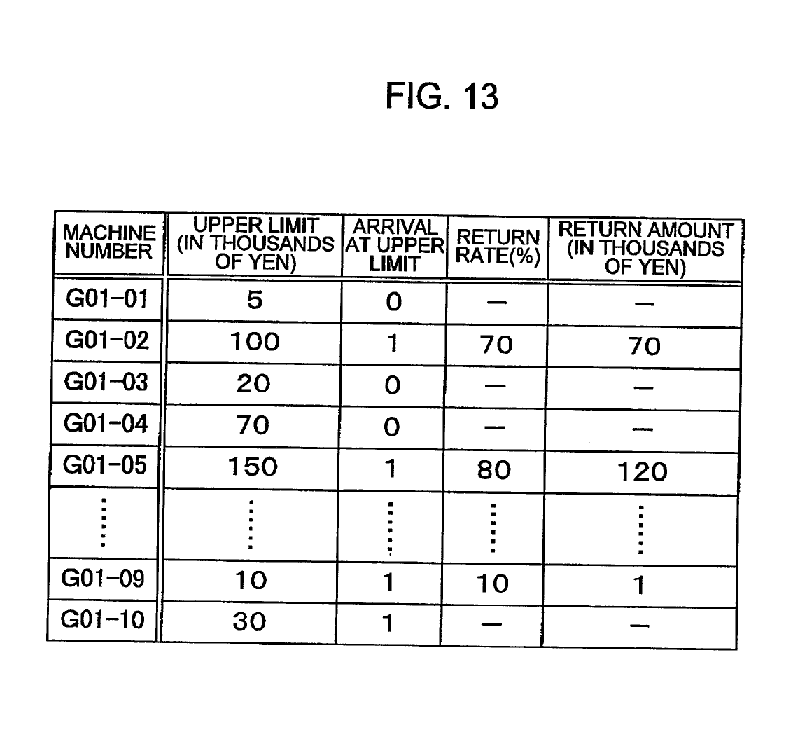

The result of the upper limit calculation is sent to the server 1 via the communication interface circuit 41, network NT, and communication interface 53. Under instruction of the CPU 51, the server 1 registers this result in the history table (see FIG. 13) stored in the database 54. The operation of registering the upper limit calculation result is performed per game machine.

Upon completing the sending of the upper limit calculation result, the CPU 33 waits for a display signal (step S66). The display signal is a signal sent from the server 1, in order that before the processing of step S64, the upper limit value set by the player is displayed on the display part 19 of the game machine 2.

At a predetermined timing, the CPU 33 judges whether the display signal is received (step S67). When the judgment result is that no display signal is received, the CPU 33 returns the processing to step S66 and waits for the display signal again. On the other hand, when the judgment result is that the display signal is received, the CPU 33 displays the upper limit value (step S68). In order to display the upper limit value, the CPU 33 applies a drive signal via the interface circuit group 39 to the display part 19, so that the upper limit is displayed on the display part 19.

Upon completing the upper limit display-processing, the CPU 33 terminates the present subroutine.

With the above configuration, the player performing a game on the game machine 2 can set an upper limit value at his/her desire. At the result, the player can enjoy the game without anxiety.

Additionally, in this preferred embodiment a return rate that is the standard for return is determined by the upper limit value that the player set. Following is the processing for determining a return rate.

Following is the processing for setting a return rate.

Processing for Setting Return Rate

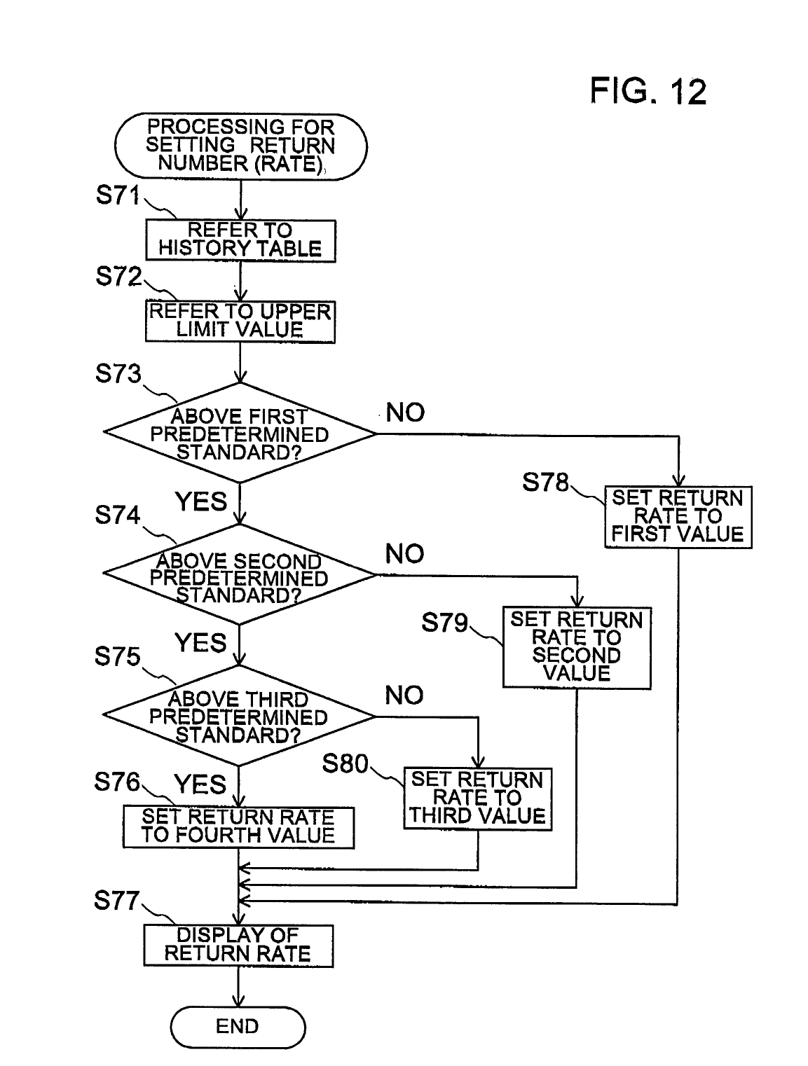

FIG. 12 is a flowchart showing the flow of operation when the game server sets a return rate. This flowchart corresponds to the subroutine of the return rate setting in step S57 shown in FIG. 10. The processing shown in FIG. 12 is performed on the server 1 that collectively controls a plurality of game machines 2.

Referring to FIG. 12, the CPU 51 with the server 1 firstly refers to a history table shown in FIG. 13 (step S71). The history table is one in which the play statuses on the individual game machines 2 and a variety of settings are registered, and which is stored in the database 54 with the server 1. Referring to FIG. 13, this history table has the following contents: (i) machine-numbers of the game machines 2 under collective control of the server 1; (ii) the upper limit values being individual to these game machines 2; (iii) data indicating whether the cumulative credit consumption of each game machine 2 reaches the upper limit; (iv) return rates; and (v) the amount of return to be executed.

In order to specify a game machine 2 to which a return number is set, data of machine-number sent from the game machine 2 is necessary. As data of machine-number, there is used a signal sent from the communication interface circuit 41 via network NT and communication interface 53 when judging whether it is a return timing, in step S56 shown in FIG. 10.

Upon completing the history table reference processing, the CPU 51 refers to an upper limit value registered in the history table (step S72). The processing for referring to the upper limit value is to refer to the numerical data in the column “upper limit (in thousands of yen)” on the history table. As will be described later, in this preferred embodiment a return rate is determined by the upper limit value, so as to execute a return according to the upper limit value set by the player. Therefore, the player can adjust gamble characteristics of a game at his/her desire.

Upon completing the upper limit reference processing, the CPU 51 judges whether a first predetermined standard of the upper limit value is not less than 10 (in thousands of yen), for example (step S73).

In the first predetermined standard judgment processing in step S73, when the judgment result is that the upper limit value set by the player is lower than the first predetermined standard, the CPU 51 moves the processing to step S78, and sets the return rate to a first value (e.g., a value not more than 20%). That is, the CPU 51 performs a lottery for selecting one numerical value from data containing various numerical values of not more than “20”. The selected numerical value data is set as a return rate to the game machine.

Upon completing the processing for setting the return rate to the first value, the CPU 51 displays the return rate (step S77). This return rate display processing is achieved by sending a signal for indicating the return rate to the display part 19 of the game machine 2 via the communication interface 53 with the server 1, network NT, and communication interface circuit 41 with the game machine 2.

When the judgment result of step S73 is that the upper limit value set by the player is not less than the first predetermined standard, the CPU 51 moves the processing to step S74, and judges whether the upper limit value is not more than a second predetermined standard (e.g., 50 (in thousands of yen)).

When the judgment result of step S74 is that the upper limit value set by the player is lower than the second predetermined standard, the CPU 51 moves the processing to step S79, and sets the return rate to a second value (e.g., a value ranging from not less than 20% to not more than 40%). That is, the CPU 51 performs a lottery for selecting one numerical value from data containing various numerical values of not less than “20” to not more than “40”. The selected numerical value data is set as a return rate to the game machine.

Upon completing the processing for setting the return rate to the second value, the CPU 51 displays the return rate (step S77).

When the judgment result of step S74 is that the upper limit value set by the player is higher than the second predetermined standard, the CPU 51 moves the processing to step S75, and judges whether the upper limit value is not less than a third predetermined standard (e.g., 100 (in thousands of yen)).

When the judgment result of step S75 is that the upper limit value set by the player is lower than the third predetermined standard, the CPU 51 moves the processing to step S80, and sets the return rate to a third value (e.g., a value ranging from not less than 30% to not more than 50%). That is, the CPU 51 performs a lottery for selecting one numerical value from data containing various numerical values of not less than “30” to not more than “50”. The selected numerical value data is set as a return rate to the game machine.

Upon completing the processing for setting the return rate to the third value, the CPU 51 displays the return rate (step S77).

When the judgment result of step S75 is that the upper limit value set by the player is higher than the third predetermined standard, the CPU 51 moves the processing to step S76, and sets the return rate to a fourth value (e.g., a value not less than 50%). That is, the CPU 51 performs a lottery for selecting one numerical value from data containing various numerical values of not less than “50” (it may be a numerical value of not less than “100”). The selected numerical value data is set as a return rate to the game machine.

When a player sets a high upper limit value by selecting a numerical value from the range of not less than “100”, there is the possibility that the player can receive a return over the upper limit, thus further increasing game characteristics.

Upon completing the processing for setting the return rate to the fourth value, the CPU 51 displays the return rate (step S77).

By checking the return rate displayed on the display part 19 of the game machine 2, the player can confirm the amount of a return to be executed when the cumulative credit consumption of the player reaches the upper limit that the player set to the present game machine. At the result, the player can continue the game without anxiety.

Upon completing the processing for displaying the return rate, the CPU 51 terminates the foregoing sequence of return rate setting processes.

Operations and Effects

This preferred embodiment produces mainly the following operations and effects.

(1) Player change on each game machine is detected and, based on the detection result, the cumulative credit consumption on each game machine is controlled per player. When the cumulative credit consumption of a player reaches an upper limit, a return to the player is executable. Thus, a return is guaranteed per player, this produces not only an anxiety-free game but also ambition to continue the game until he/she receives a return.

(2) Players can select and set any upper limit as standard for return, thereby enjoying a game in accordance with their desires. It is therefore possible to eliminate the conventional problem of missing customers.

While but one embodiment of the invention has been shown and described, it will be understood that many changes and modifications may be made therein without departing from the spirit or scope of the present invention.

What is claimed is:

1. A game machine that is brought into a status enabling to start a game based on a thrown coin or given credit number and is given payout according to a result of said game, said game machine including:
a judge means for judging cumulative credit consumption based on information about credit consumption in said game machine;
a return means for executing a return based on a predetermined return rate, when said judge means judges that said cumulative credit consumption reaches a predetermined upper limit, or executing the return based on a result of a lottery for determining whether the return is reliably executed; and
an upper limit setting means for setting an upper limit by the operation of a player performing a game on a game machine.

2. The game machine according to claim 1 wherein
said predetermined return rate is determined by a value of the predetermined upper limit that is set by said upper limit setting means.

3. The game machine according to claim 1 further including:
a display means for displaying either (i) the value of said predetermined upper limit and said cumulative credit consumption return rate; or (ii) a ratio of said cumulative credit consumption to said predetermined upper limit.

4. The game machine according to claim 2 further including:
a display means for displaying either (i) the value of said predetermined upper limit and said cumulative credit consumption return rate; or (ii) a ratio of said cumulative credit consumption to said predetermined upper limit.

5. A game server for collectively controlling a plurality of game machines which are brought into a status enabling to start a game based on a thrown coin or given credit number, and are given payout according to a result of said game, said game server including:
a judge means for judging cumulative credit consumption based on information about credit consumption in a game machine with which a player performs a game;
a return means for executing a return based on a predetermined return rate, when said judge means judges that said cumulative credit consumption reaches a predetermined upper limit, or executing the return based on a result of a lottery for determining whether the return is reliably executed; and
a receiving means for receiving upper limit information about a value of the predetermined upper limit sent from said game machine; and
a first sending means for sending a signal for setting said predetermined upper limit value based on said upper limit information received by said receive means.

6. The game server according to claim 5 wherein
said predetermined return rate is determined by the upper limit value contained in said upper limit information received by said receiving means.

7. The game server according to claim 5 further including:
a second sending means for sending a signal for displaying on a display part of said game machine either (i) the value of said predetermined upper limit and said cumulative credit consumption return rate; or (ii) a rate of said cumulative credit consumption to said predetermined upper limit.

8. The game server according to claim 6 further including:
a second sending means for sending a signal for displaying on a display part of said game machine either (i) the value of said predetermined upper limit and said cumulative credit consumption return rate; or (ii) a rate of said cumulative credit consumption to said predetermined upper limit.

9. A method for collectively controlling a plurality of game machines which are brought into a status enabling to start a game based on a thrown coin or given credit number, and are given payout according to a result of said game, said method including:
a detection step for detecting cumulative credit consumption on said plurality of game machines;
a return step for executing a return based on a predetermined return rate to a game machine having a result of said detection step that said cumulative credit consumption reaches a predetermined upper limit, or executing the return based on a result of a lottery for determining whether the return is reliably executed; and
a receiving step for receiving upper limit information about a value of the predetermined upper limit sent from said game machine; and
a first sending step for sending a signal for setting said predetermined upper limit value based on said upper limit information received by said receiving step.

10. The method according to claim 9 wherein
said predetermined return rate is determined by the upper limit value contained in said upper limit information received in said receiving step.

11. The method according to claim 9 further including:
a second sending step for sending a signal for displaying on a display part of said game machine either (i) the value of said predetermined upper limit and said cumulative credit consumption return rate; or (ii) a ratio of said cumulative credit consumption to said predetermined upper limit.

12. The method according to claim 10 further including:
a second sending step for sending a signal for displaying on a display part of said game machine either (i) the value of said predetermined upper limit and said cumulative credit consumption return rate; or (ii) a ratio of said cumulative credit consumption to said predetermined upper limit,
